(19) United States
(12) Patent Application Publication
(10) Pub. No.: US 2022/0387857 A1
(43) Pub. Date: Dec. 8, 2022

(54) GOLF BALL

(71) Applicant: BRIDGESTONE SPORTS CO., LTD., Tokyo (JP)

(72) Inventor: Atsushi KOMATSU, Chichibushi (JP)

(73) Assignee: BRIDGESTONE SPORTS CO., LTD., Tokyo (JP)

(21) Appl. No.: 17/828,842

(22) Filed: May 31, 2022

(30) Foreign Application Priority Data
Jun. 1, 2021 (JP) 2021-092015

(51) Int. Cl. A63B 37/00; C08K 5/14

(52) U.S. Cl. CPC A63B 37/0075; A63B 37/0065; A63B 37/00921; A63B 37/0087; C08K 5/14; A63B 2209/00; A63B 37/0096

(57) ABSTRACT

In a golf ball having a core, a cover and at least one intermediate layer between the core and the cover, the core is made of a material molded under heat from a rubber composition that includes (a) a base rubber, (b) a co-crosslinking agent which is an α,β-unsaturated carboxylic acid and/or a metal salt thereof, (c) an organic peroxide, (d) water, and (e) an antioxidant which is a benzimidazole of a specific formula and/or a metal salt thereof. The core and ball have compressive deformations within specific respective ranges when subjected to given loading conditions. This golf ball exhibits a low spin rate on shots, enabling the flight performance of the ball to be improved.

### CROSS-REFERENCE TO RELATED APPLICATION

This non-provisional application claims priority under 35 U.S.C. § 119(a) on Patent Application No, 2021-092015 filed in Japan on Jun. 1, 2021, the entire contents of which are hereby incorporated by reference.

### TECHNICAL FIELD

The present invention relates to a multi-piece solid golf ball having a structure of three or more layers that includes a core, a cover and at least one intermediate layer between the core and the cover.

### BACKGROUND ART

Golf balls lately are predominantly either two-piece solid golf balls or three-piece solid golf balls. These golf balls generally have a structure in which a cover of one layer or a plurality of layers that is made of various resin materials encases a core made of a rubber composition. The core accounts for most of the golf ball volume and exerts a large influence on ball properties such as rebound, feel on impact and durability, Recently, a number of disclosures have been made in which the cross-sectional hardness of the core is suitably adjusted so as to achieve a specific core hardness gradient, thereby optimizing the spin properties of the ball on full shots with a driver or an iron and enabling the ball to travel an increased distance. Enlarging the hardness difference between the surface and the center of the core is known have the effect of reducing the spin rate on full shots with a driver. Moreover, it is known from prior findings that a reduced spin rate on full shots leads to an increased distance. Accordingly, in order to improve the distance traveled by a golf ball, there is a desire for art that enlarges the hardness difference at the core interior. One approach that has been proposed for achieving this aim is to give the core a structure made of two rubber layers. However, producing such a core would entail a relatively large number of operations compared with a single-layer rubber core, and so there remains a desire for art that enlarges the hardness difference within a single-layer core.

Methods for adjusting the cross-sectional hardness of the core include, for example, suitably adjusting the compounding ingredients in the rubber composition of the core and also the vulcanization temperature and time. Alternatively, with regard to the compounding ingredients in the rubber composition of the core, another method involves carefully selecting the types of co-crosslinking agent and organic peroxide used and adjusting the contents of these. The use of methacrylic acid, acrylic acid and metal salts thereof as co-crosslinking agents is known in the field of golf balls. However, adjustment in the compounding of such co-crosslinking agents is intended primarily to modulate the feel of the ball on impact by regulating the core hardness, and is incapable of satisfying the desired spin properties.

JP-A H11-169485 discloses art in which a specific amount of polyethylene glycol is included in a core-forming rubber composition. Yet, the object of this prior art is to improve the mold releasability of a rubber molding (core) by including polyethylene glycol as an internal mold release agent. It is not aimed at further improving the internal hardness of rubber moldings and lowering the spin rate of golf balls by judicious selection of the types of compounding ingredients used in a core-forming rubber composition.

JP-A 2013-108079 and JP-A 2013-108080 describe art which, as a result of investigations on various additives included in rubber compositions for golf balls, increases the resilience of a vulcanized rubber material and imparts a suitable hardness by adding a specific benzimidazole such as 2-mercaptobenzimidazole. However, such rubber compositions are not aimed at improving the internal hardness of rubber moldings and lowering the spin rate of golf balls.

JP-A 2015-47502 discloses art which includes water and/or a metal monocarboxylate in the base rubber of a rubber composition for a golf ball core and thus increases the distance of the ball by maintaining a good ball rebound and lowering the spin rate, and moreover provides the ball with an excellent durability. However, even in this art, the golf ball spin rate-lowering effect is inadequate. Hence, there remains room for improvement in the spin rate-lowering effect.

The present applicant earlier disclosed a rubber composition for golf balls in which the addition of, together with water or an alcohol, a specific benzimidazole and/or metal salt thereof as an antioxidant to a core material sets the hardness difference between the core center and core surface to a large value, thus exhibiting low spin properties when the golf hall is struck (JP-A 2020-2233), However, this prior-art disclosure focuses solely on the internal hardness of the core and does not optimize the hardness at the surface of each layer encasing the core or the compressive deformation (deflection) of the core or ball when compressed under a specific load. Hence, there remains room for improving the spin rate-lowering properties of the ball by improving the structure of the overall ball.

### SUMMARY OF THE INVENTION

It is therefore an object of the present invention to provide a golf ball in which, by setting hardness differences in the core internal hardness profile to large values and also optimizing the amount of compressive deformation of the overall ball structure when compressed under a specific load, low spin properties are exhibited on golf ball shots, enabling the flight performance to be improved.

As a result of intensive investigations, T have discovered that, with regard to a golf ball having a core, a cover and at least one intermediate layer between the core and the cover, by having a rubber composition for the core include as the essential compounding ingredients (a) a base rubber, (b) a co-crosslinking agent that is an α,β-unsaturated carboxylic acid and/or a metal salt thereof, (c) an organic peroxide, (d) water and (e) an antioxidant that is a benzimidazole of a specific formula and/or a metal salt thereof, and by also setting the amounts of compressive deformation (also referred to as “deflection”) by the core and the ball when compressed under a final load of 1,275 N (130 kgf) from an initial load of 98 N (10 kgf) within specific respective ranges, low spin properties can be fully exhibited on golf ball shots, in addition to which a good durability can be maintained.

Also, in JP-A 2020-2233 filed by the present applicant, examples are described in which the core has a compressive deformation under specific loading of close to 4.0 mm. In the present invention, the compressive deformation of the core is in a low-hardness region of 4.1 mm or more. Yet, even in this low-hardness (large-deflection) region, by using both (d) water and (e) a specific antioxidant together in the core-forming rubber composition, I have discovered formulations which result in a larger hardness difference between the core center and core surface, and have thus succeeded in lowering the spin rate of the ball on driver (W #1) shots. Moreover, in a low-hardness region where, as noted above, the compressive deformation of the core is 4.1 mm or more, the ball itself generally ends up becoming too soft, cracking becomes more frequent and the durability worsens. However, in the golf ball of the invention, by forming two or more layers— these being an intermediate layer and a cover (outermost layer)— as the layers encasing the core, a good durability can be maintained.

Accordingly, the invention provides a golf ball having a core, a cover and at least one intermediate layer between the core and the cover, wherein the core is made of a material molded under heat from a rubber composition which includes (a) a base rubber, (b) a co-crosslinking agent which is an α,β-unsaturated carboxylic acid and/or a metal salt thereof, (c) an organic peroxide, (d) water and (e) an antioxidant which is a benzimidazole of the following general formula and/or a metal salt thereof

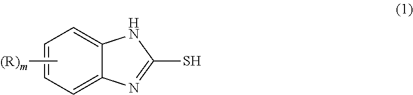

(wherein R is a hydrogen atom or a hydrocarbon group of 1 to 20 carbon atoms and in is an integer from 1 to 4, with each R being the same or different when m is 2 or more). The core has a compressive deformation of at least 4.1 mm when compressed under a final load of 1,275 N (130 kgf) from an initial load of 98 N (10 kgf), and the ball has a compressive deformation of at least 3.0 mm when compressed under a final load of 1,275 N (130 kgf) from an initial load of 98 N (10 kgf).

In a preferred embodiment of the golf ball of the invention, component (e) is 2-mercaptobenzimidazole.

In another preferred embodiment of the inventive golf ball, the content of component (d) per 100 parts by weight of component (a) is at least 1.0 part by weight and the content of component (e) per 100 parts by weight of component (a) is at least 0.1 part by weight.

In yet another preferred embodiment, the intermediate layer has a material hardness on the Shore D hardness scale of at least 50, the cover has a material hardness on the Shore D hardness scale of at least 60, and the golf ball satisfies the following hardness relationship:

(1) material hardness of cover>material hardness of intermediate layer>core surface hardness>core center hardness.
In this embodiment, it is preferable for the hardness relationship between the core and the cover to satisfy the following condition:
(2) (Shore D hardness of cover material)—(Shore D hardness at core center)≥30.

### Advantageous Effects of the Invention

In the golf ball of the invention, by selling the hardness difference between the core surface and the core center to a large value and also setting within specific respective ranges the compressive deformations of the core and ball when subjected to given loading conditions, the ball exhibits low spin properties when struck, enabling the flight performance to be to improved.

### BRIEF DESCRIPTION OF THE DIAGRAMS

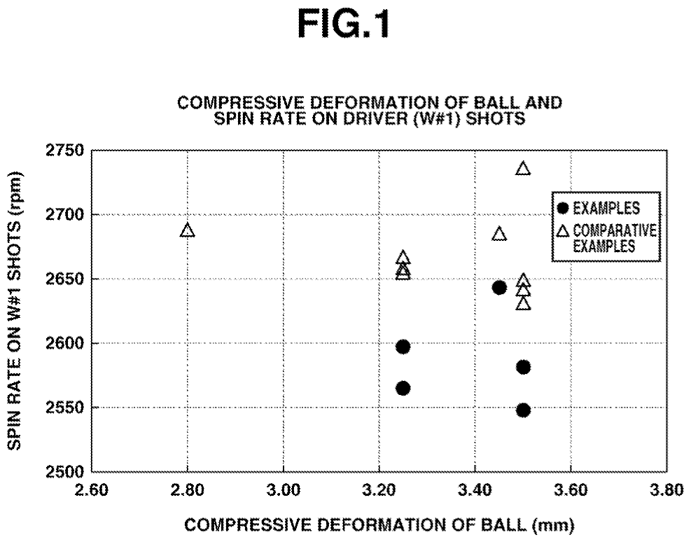

FIG. 1 is a graph of the relationship between the compressive deformation of the golf ball and the spin rate on shots with a driver (W #1) in the Examples and Comparative Examples.

### DESCRIPTION OF THE PREFERRED EMBODIMENTS

The objects, features and advantages of the invention will become more apparent from the following detailed description taken in conjunction with the appended diagram.

The golf ball of the invention is a multi-piece solid golf ball having a structure of three or more layers that includes, from the inside: a core, an intermediate layer and a cover. The invention provides, in particular, the following rubber composition (core formulation) which is ideally suited for a distance ball in the low-hardness region.

The core is characterized by being made of a material molded under heat from a rubber composition which includes the following components:

(a) a base rubber,
(b) a co-crosslinking agent which is an α,β-unsaturated carboxylic acid and/or a metal salt thereof,
(c) an organic peroxide,
(d) water, and
(e) an antioxidant which is a benzimidazole of a specific formula and/or a metal salt thereof.

The base rubber serving as component (a) is not particularly limited, although it s especially suitable to use a polybutadiene.

It is desirable for the polybutadiene to have, on the polymer chain thereof, a cis-1,4 bond content of at least 60%, preferably at least 80%, more preferably at least 90%, and most preferably at least 95%. When cis-1,4 bonds account for too few of the bonds on the polybutadiene molecule, the resilience may decrease.

The content of 1,2-vinyl bonds on the polybutadiene is generally 2% or less, preferably 1.7% or less, and more preferably 1.5% or less, of the polymer chain. When the content of 1,2-vinyl bonds is too high, the resilience may decrease.

The polybutadiene has a Mooney viscosity (ML₁₊₄ (100° C.)) of preferably at least 20, and more preferably at least 30. The upper limit is preferably not more than 120, more preferably not more than 100, and even more preferably not more than 80.

The term “Mooney viscosity” used herein refers to an industrial indicator of viscosity (JIS K 6300) measured with a Mooney viscometer, which is a type of rotary plastometer. This value is represented by the unit symbol ML₁₊₄ (100° C.), wherein “M” stands for Mooney viscosity, “L” stands for large rotor (L-type) and “1+4” stands for a pre-heating time of 1 minute and a rotor rotation time of 4 minutes. The “100° C.” indicates that measurement was carried out at a temperature of 100° C.

The polybutadiene used may be one synthesized with a rare-earth catalyst or a group VIII metal compound catalyst.

A polybutadiene rubber synthesized with a catalyst differing from the above lanthanum rare-earth compound may be included in the base rubber. In addition, styrene-butadiene rubber (SBR), natural rubber, polyisoprene rubber, ethylene-propylene-diene rubber (EPDM) or the like may also be included. These may be used singly or two or more may be used in combination.

The polybutadiene accounts for a proportion of the overall rubber that is preferably at least 60 wt %, more preferably at least 70 wt %, and most preferably at least 90 wt %. The above polybutadiene may account for 100 wt % of the base rubber; that is, it may account for all of the base rubber.

Next, component (b) is a co-crosslinking agent which is an α,β-unsaturated carboxylic acid and/or a metal salt thereof. The number of carbon atoms on this unsaturated, carboxylic acid is preferably from 3 to 8. Specific examples include unsaturated carboxylic acids such as acrylic acid, methacrylic acid, maleic acid and fumaric acid. Specific examples of the metal in the metal salts of these unsaturated carboxylic acids include zinc, sodium, magnesium, calcium and aluminum, with zinc being especially preferred. The co-crosslinking agent is most preferably zinc acrylate.

The content of component (b) per 100 parts by weight of the base rubber serving as component (a) is preferably at least 10 parts by weight, more preferably at least 15 parts by weight, and even more preferably at least 20 parts by weight. The upper limit is preferably not more than 65 parts by weight, more preferably not more than 60 parts by weight, and even more preferably not more than 55 parts by weight. At a content lower than this range, the ball may be too soft and have a poor rebound. At a content higher than this range, the ball may be too hard, resulting in a poor feel on impact, and may also be brittle and thus have a poor durability.

The co-crosslinking agent serving as component (b) has a mean particle size of preferably from 3 to 30 μm, more preferably from 5 to 25 μm, and even more preferably from 8 to 15 μm. At a mean particle size for the co-crosslinking agent that is below 3 μm, the co-crosslinking agent tends to agglomerate within the rubber composition, leading to a rise in reactivity between molecules of acrylic acid and a decline in reactivity between molecules of the base rubber, as a result of which the golf ball may be unable to achieve a sufficient rebound performance. At a mean particle size for the co-crosslinking agent in excess of 30 μm, the co-crosslinking agent particles become too large, increasing the variability in the properties of the resulting golf balls.

Component (c) is an organic peroxide. It is preferable to use as this organic peroxide one having a one minute half-life temperature of between 110 and 185° C. Examples of such organic peroxides include dicumyl peroxide (Percumyl D, from NOF Corporation), 2,5-dimethyl-2,5-di(t-bulylperoxy)hexane (Perhexayl 25B, from NOF Corporation) and di(2-t-butyliperoxyisopropyl)benzene (Perbutyl P, from NOF Corporation). The use of dicumyl peroxide is preferred. Other commercial products include Perhexa C-40, Niper BW and Peroyl L (all from NOF Corporation), and Luperco 231XL (from AtoChem Co.). These may be used singly, or two or more may be used together.

The content of component (c) per 100 parts by weight of the base rubber is preferably at least 0.1 part by weight, and more preferably at least 0.3 part by weight. The upper limit is preferably not more than 5 parts by weight, more preferably not more than 4 parts by weight, and even more preferably not more than 3 parts by weight.

The water serving as component (d) is not particularly limited, and may be distilled water or tap water. The use of distilled water that is free of impurities is especially preferred.

The amount of component (d) included per 100 parts by weight of the base rubber is preferably at least 1.0 part by weight, and more preferably at least 1.2 parts by weight. The upper limit is preferably not more than 2.5 parts by weight, and more preferably not more than 2.0 parts by weight. By setting the component (d) content within the above range, the hardness difference between the inside and outside of a soft core can be made large. When too much component (d) is included, the hardness decreases and it may not be possible to obtain the desired feel on impact, durability and rebound. When too little component (d) is included, the desired core hardness profile may not be obtained and it may not be possible to fully achieve a ball spin rate-lowering effect on shots.

Component (e) is a benzimidazole of the following general formula and/or a metal salt thereof, and is used as an antioxidant,

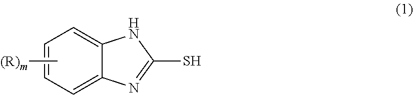

In formula (1), R is a hydrogen atom or a hydrocarbon group of 1 to 20 carbon atoms and m is an integer from 1 to 4, with each R being the same or different when m is 2 or more. Specific examples of the benzimidazole of formula (1) include 2-mercaptobenzoimidazole, 2-mercaptomethylbenzoimidazole, and metal salts of these. The metal salts are preferably zinc salts.

The amount of benzimidazole of the above specific formula and/or metal salt thereof included as component (e) per 100 parts by weight of the base rubber is preferably at least 0.1 part by weight, and more preferably at least 0.3 part by weight. The upper limit is preferably not more than 5 parts by weight, and more preferably not more than 3 parts by weight. By setting the content of component (e) within this range, the hardness difference between the inside and outside of the soft core can be made larger owing to the effects of use together with component (d). When the component (e) content is too small, crosslinking reactions near the core surface may not proceed efficiently, as a result of which the crosslink density may not become high enough and a layer having a high hardness may not fully form. Also, with regard to the overall core, the hardness difference between the core surface and the core center may not become large enough, in addition to which the ball may lack sufficient durability on impact. On the other hand, even when an excessive amount of component (e) is included, the advantageous effects are no better than those obtained with the above-indicated preferred amount of addition.

Aside from above components (a) to (e), various additives such as fillers, organosulfur compounds and processing aids may be included, provided that doing so is not detrimental to the objects of the invention.

Examples of fillers that may be suitably used include zinc oxide, barium sulfate to and calcium carbonate. These may be used singly, or two or more may be used together. The filler content per 100 parts by weight of the base rubber may be set to preferably at least 1 part by weight, more preferably at least 3 parts by weight, and even more preferably at least 5 parts by weight. The upper limit in the filler content per 100 parts 1 by weight of the base rubber may be set to preferably not more than 100 parts by weight, more preferably is not more than 60 parts by weight, and even more preferably not more than 40 parts by weight. At a filler content that is too high or too low, it may not be possible to obtain a proper weight and a suitable rebound.

The organosulfur compounds are not particularly limited. Examples include thiophenols, thionaphthols, diphenylpolysulfides, halogenated thiophenols, and metal salts of these. Specific examples include the zinc salts of pentachlorothiophenol, pentafluorothiophenol, pentabromothiophenol and p-chlorothiophenol, and any of the following having 2 to 4 sulfur atoms: diphenylpolysulfides, dibenzylpolysulfides, dibenzoylpolysulfides, dibenzothiazoylpolysulfides, dithiobenzoylpolysulfides and 2-thionaphthols. These may be used singly, or two or more may be used together. Of these, preferred use can be made of the zinc salt of pentachlorothiophenol and/or diphenyldisulfide.

It is recommended that the amount of organosulfur compound included per 100 parts by weight of the base rubber be preferably at least 0.05 part by weight, more preferably at least 0.1 part by weight, and even more preferably at least 0.2 part by weight, and that the upper limit be preferably not more than 3 parts by weight, more preferably not more than 2 parts by weight, and even more preferably not more than 1 part by weight. Including too much organosulfur compound may result in a rubber vulcanizate that has too low a hardness. On the other hand, including too little may make a rebound-improving effect unlikely.

Processing aids that may be suitably used include higher fatty acids and metal salts thereof. Examples of higher fatty acids include stearic acid; palmitic acid, oleic acid; linoleic acid, linolenic acid and myristic acid. Stearic acid is especially preferred. Examples of higher fatly acid metal salts include lithium salts, sodium salts, potassium salts, copper salts, magnesium salts, calcium salts, strontium salts, barium salts, tin salts, cobalt salts, nickel salts, zinc salts and aluminum salts. The use of zinc stearate is especially preferred. The amount of processing aid included per 100 parts by weight of the base rubber may be set to preferably at least 1 part by weight, more preferably at least 3 parts by weight, and even more preferably at least 5 parts by weight. The upper limit in the amount of addition per 100 parts by weight of the base rubber may be set to preferably not more than 20 parts by weight, more preferably not more than 15 parts by weight, and even more preferably not more than 10 parts by weight. When too much is added, a sufficient hardness and rebound may not be obtained; when too little is added, the chemicals that are added may not fully disperse and it may not be possible to obtain the expected properties. Examples of methods that may be used to add the processing aid include, but are not particularly limited to: charging the processing aid into a mixer at the same time as other chemicals, adding the processing aid after first mixing it together with other chemicals such as component (h), adding the processing aid after coating it onto the surface of other chemicals such as component (b), and adding the processing aid after first preparing a masterbatch of it together with component (a).

In this invention, a specific antioxidant is used as component (e), but an antioxidant differing from component (e) may be included as component (I). Specific examples of component (f) include hindered phenol-type antioxidants such as 2,6-di-tert-butyl-4-methylphenol, 2,6-di-tert-butyl-4-ethylphenol, pentaerythritol tetrakis[3-(3,5-di-Cert-butyl-4-hydroxyphenyl)propionate] and 1,3,5-tris(3′,5-di-t-butyl-4-hydroxybenzyl)isocyanuric acid. Commercial products that can be used include Nocrac 200, Nocrac M-17 (both from Ouchi Shinko Chemical Industry Co., Ltd.), Irganox 1010 (from BASF) and ADK Stab AO-20 (from Adeka). These may be used singly, or two or more may be used together. The amount of this antioxidant included per 100 parts by weight of the base rubber, although not particularly limited, is preferably at least 0.05 part by weight, and more preferably at least 0.1 part by weight. The upper limit is preferably not more than 1.0 part by weight, more preferably not more than 0.7 part by weight, and even more preferably not more than 0.4 part by weight. When too much or too little is included, a proper core hardness gradient may not be obtained, as a result of which it may not be possible to achieve a good rebound, a good durability and a good spin rate-lowering effect on full shots.

The core is a vulcanizate produced by vulcanizing/curing the above rubber composition. The core may be composed of a single layer or a plurality of layers, and the vulcanizate can be used as part or all of a single-layer or multilayer core. For example, a core which is a vulcanizate can be produced by using a mixing apparatus such as a Banbury mixer or a roll mill to knead the rubber composition, then using a core mold to compression mold or injection mold the kneaded composition and suitably heating the molded body at a temperature suitable for the organic peroxide and co-crosslinking agent to act, such as at between about 100° C. and about 200° C. for a period of 10 to 40 minutes, so as to cure the molded body.

By compounding the ingredients as described above, the core can be conferred with a hardness gradient in which the difference in hardness between the surface and the center thereof is large, enabling the durability of the golf ball to be increased while maintaining good spin properties.

The core has a diameter which, although not particularly limited, depends also on the layer structure of the golf ball to be manufactured. The core diameter is preferably at least 30 mm, and more preferably at least 35 mm, but is preferably not more than 41 mm, and more preferably not more than 40 mm. At a core diameter outside of this range, the initial velocity of the ball may decrease or a suitable spin performance may not be obtained.

The core has a center hardness on the JIS-C hardness scale which, although not particularly limited, is preferably at least 40, more preferably at least 45, and even more preferably at least 50. The upper limit is preferably not more than 75, more preferably not more than 70, and even more preferably not more than 65. At a core center hardness outside of this range, the feel on impact may be poor, the durability may decline and it may not be possible to obtain a spin rate-lowering effect.

The core has a surface hardness on the JIS-C hardness scale which, although not particularly limited, is preferably at least 65, more preferably at least 70, and even more preferably at least 72. The upper limit is preferably not more than 95, more preferably not more than 90, and even more preferably not more than 88. When the surface hardness of the core is lower than this range, the ball rebound may decrease, as a result of which a sufficient distance may not be achieved. On the other hand, when the surface hardness of the core is higher than the above range, the feel at impact may be too hard and the durability to cracking on repeated impact may worsen.

The core has a hardness profile such that the hardness difference between the surface and center of the core is sufficiently large. Specifically, the difference in hardness on the JIS-C scale between the core surface (X) and the core center (Y), expressed as X Y, is preferably at least 20, more preferably at least 25, and even more preferably at least 30. The upper limit is preferably not more than 50, more preferably not more than 45, and even to more preferably not more than 40. When this hardness difference value is too small, the spin rate-lowering effect on shots with a W #1 may be inadequate and a good distance may not be achieved. On the other hand, when this hardness difference is too large, the initial velocity of the ball when struck may become lower, resulting in a shorter distance, or the durability of the ball to cracking on repeated impact may worsen. Here, “center hardness” refers to the hardness measured at the center of the cross-section obtained by cutting the core through the center, and “surface hardness” refers to the hardness measured at the spherical surface of the core. “JIS-C hardness” refers to the hardness measured with a spring-type durometer (JIS-C model) as specified in JIS K 6301-1975.

The core hardness gradient used in this invention is preferably one in which the hardness remains the same or increases, but does not decrease, from the center toward the surface of the core.

It is critical for the core (vulcanizate) to have a compressive deformation when compressed under a final load of 1,275 N (130 kgf) from an initial load of 98 N (10 kgf) which is at least 4.1 mm. This compressive deformation is preferably at least 4.2 mm, and more preferably at least 4.5 mm. Although there is no particular upper limit, the compressive deformation of the core is preferably not more than 6.0 mm, more preferably not more than 5.5 mm, and even more preferably not more than 5.0 mm. When this value is too large, the core becomes too soft, as a result of which a sufficient spin rate-lowering effect may not be obtained and the resilience may decrease. When this value is too small, a spin rate-lowering effect cannot be obtained and the feel of the ball on impact becomes hard.

In this invention, at least one intermediate layer is provided between the core and the outermost layer of the cover.

A known thermoplastic resin material such as any of the various ionomer resins that are employed in golf halls may be used without particular limitation as the resin material making up the intermediate layer.

To achieve an even further spin rate-lowering effect in the ball, it is especially desirable to use a highly neutralized ionomeric material as the intermediate layer material. Specifically, it is preferable to use a material obtained by blending components (i) to (iv) below:

100 parts by weight of a resin component composed of, in admixture,
(i) a base resin of (i-1) an olefin-unsaturated carboxylic acid random copolymer and/or a metal ion neutralization product of an olefin-unsaturated carboxylic acid random copolymer mixed with (i-2) an olefin-unsaturated carboxylic acid-unsaturated carboxylic acid ester random terpolymer and/or a metal ion neutralization product of an olefin-unsaturated carboxylic acid-unsaturated carboxylic acid ester random terpolymer in a weight ratio between 100:0 and 0:100, and
(ii) a non-ionomeric thermoplastic elastomer in a weight ratio between 100:0 and 50:50;
(iii) from 5 to 80 parts by weight of a fatty acid and/or fatty acid derivative having a molecular weight of from 228 to 1,500; and
(iv) from 0.1 to 17 parts by weight of a basic inorganic metal compound capable of neutralizing un-neutralized acid groups in components (i) and (iii).
In particular, when using a mixed material of components (i) to (iv), it is preferable to utilize one in which at least 70% of the acid groups are neutralized.

The intermediate layer may be set to a material hardness on the Shore D hardness scale of at least 50, and preferably at least 55. Although there is no particular upper limit, the material hardness may be set to preferably not more than 65, and more preferably not more than 60.

The intermediate layer is set to a thickness of 2.0 mm or less, preferably 1.8 mm or less, and more preferably 1.5 mm or less. Although there is no particular lower limit, the thickness is preferably at least 0.8 mm, more preferably at least 1.0 mm, and even more preferably at least 1.2 mm. At an intermediate layer thickness outside of this numerical range, the low spin rate effect on shots with a driver (W #1) may be inadequate and a good distance may not be achieved.

Formation of the intermediate layer may be carried out in a customary manner, such as by a known injection molding method. For example, an encased sphere may be obtained by injecting an intermediate layer material over the core in an injection mold, or an intermediate layer-encased sphere may be fabricated by enclosing the core within, as the intermediate layer material, two half-cups that have been pre-molded into hemispherical shapes and then molding under applied heat and pressure.

The resin material in the cover, although not particularly limited, may be an ionomer resin or a highly neutralized resin material of the same type as or of a different type from the above-described intermediate layer material, or may be composed primarily of a polyurethane resin such as a thermoplastic polyurethane elastomer.

The cover has a material hardness on the Shore D hardness scale which is preferably at least 50, more preferably at least 55, and even more preferably at least 60. Although the material hardness of the cover has no particular upper limit, it may be set to preferably not more than 70, and more preferably not more than 65.

The cover thickness is set to not more than 2.0 mm, preferably not more than 1.8 mm, and more preferably not more than 1.5 mm. Although there is no particular lower limit, the thickness is preferably at least 0.6 mm, more preferably at least 0.8 mm, and even more preferably at least 1.0 mm. When the cover thickness falls outside of the above numerical range, the spin rate-lowering effect on shots with a driver (W #1) may be inadequate, as a result of which a good distance may not be achieved. On the other hand, when the cover thickness is too small, the ball durability may worsen.

The hardness relationship among the core, intermediate layer and cover preferably satisfies the following hardness relationship:

(1) material hardness of cover>material hardness of intermediate layer>core surface hardness>core center hardness.

That is, golf halls which satisfy the above relationship (1), by setting the hardness so as to gradually increase from the core outward to the cover (outermost layer), are golf balls specialized as distance balls.

To achieve a reduction in the spin rate on shots with a driver (W #1), it is preferable for the hardness relationship between the core and the cover to satisfy the following condition:

(2) (Shore D hardness of cover material)—(Shore D hardness at core center)≥30.

The value of (Shore D hardness of cover material)—(Shore D hardness at core center) is preferably at least 30, more preferably at least 32, and even more preferably at least 35.

In particular, golf balls which satisfy above formula (2) have a structure in which the center is softer and the cover is harder, enabling an optimal structure to be achieved as a distance ball that sufficiently lowers the spin rate on shots with a driver (W #1).

To obtain the cover in this invention, use may be made of, for example, a method that involves placing within a mold a single-layer core or a multilayer core of two or more layers that has been prefabricated according to the type of ball, mixing and melting the above mixture under applied heat, and injection-molding the molten mixture over the core so as to encase the core with the desired cover. The cover producing operations in this case can be carried out in a state where excellent thermal stability, flowability and processability are assured. As a result, the golf ball ultimately obtained has a high rebound, and moreover has a good feel on impact and excellent scuff resistance. Alternatively, use may be made of a cover-forming method other than the foregoing, such as one in which, for example, a pair of hemispherical half-cups are molded beforehand from the cover material described above, following which the core is enclosed within the half-cups and molding is carried out under applied pressure at between 120° C. and 170° C. for a period of 1 to 5 minutes.

Numerous dimples are formed on the surface of the outermost layer of the cover. In addition, the cover may be subjected to various types of treatment, such as surface preparation, stamping and painting. In cases where such surface treatment is imparted to the cover formed of the above cover material, the good moldability of the cover surface enables the work to be carried out efficiently.

This invention provides a golf ball having a core in the low hardness region. The golf ball of the invention has a compressive deformation when compressed under a final load of 1,275 N (130 kgf) from an initial load of 98 N (10 kgf) which must be at least 3.0 mm, and is preferably at least 3.1 mm, and more preferably at least 3.2 mm. The upper limit is preferably not more than 5.0 mm, and more preferably not more than 4.5 mm. When the compressive deformation of the golf ball is too small, that is, when the ball is too hard, a sufficient spin rate-lowering effect cannot be obtained and the feel at impact is hard. On the other hand, when the compressive deformation is too large, that is, when the ball is too soft, the core inner-outer hardness difference is small and a sufficient spin rate-lowering effect cannot be obtained, as a result of which the rebound may decrease.

### EXAMPLES

Examples and Comparative Examples are given below by way of illustration, although the invention is not limited by the following Examples.

### Examples 1 to 5. Comparative Examples 1 to 9

In Examples 1 and 2 and Comparative Examples 1 and 2, cores having a diameter of 37.6 mm were produced by using the rubber formulations composed primarily of polybutadiene shown in Table 1 below to prepare core compositions, subsequently vulcanizing the compositions at 155° C. for 20 minutes, and then abrading the core surface.

In Examples 3 to 5 and Comparative Examples 3 to 9, cores having a diameter of 37.6 mm are produced by using the rubber formulations composed primarily of polybutadiene shown in Table 1 below to prepare core compositions, subsequently vulcanizing the compositions at 155° C. for 20 minutes, and then abrading the core surface.

TABLE 1

| | Example | | | | | Comparative Example | | | | | | | | |
|---|---|---|---|---|---|---|---|---|---|---|---|---|---|---|
| | 1 | 2 | 3 | 4 | 5 | 1 | 2 | 3 | 4 | 5 | 6 | 7 | 8 | 9 |
| Polybutadiene | 100 | 100 | 100 | 100 | 100 | 100 | 100 | 100 | 100 | 100 | 100 | 100 | 100 | 100 |
| Zinc acrylate | 35.5 | 32.5 | 37.4 | 34.4 | 35.5 | 33.4 | 30.9 | 35.4 | 32.9 | 35.5 | 33.0 | 19.0 | 39.8 | 33.4 |
| Organic peroxide (I) | 1.0 | 1.0 | 1.0 | 1.0 | 1.0 | 1.0 | 1.0 | 1.0 | 1.0 | 1.0 | 1.0 | 0.6 | 1.0 | 1.0 |
| Organic peroxide (II) | | | | | | | | | | | | 1.2 | | |
| Water | 1.4 | 1.4 | 1.6 | 1.6 | 1.4 | 1.0 | 1.0 | 1.2 | 1.2 | 1.4 | 1.4 | | 1.4 | 1.0 |
| Antioxidant (I) | 0.3 | 0.3 | 0.3 | 0.3 | 0.3 | | | | | | | | 0.3 | |
| Antioxidant (II) | | | | | | 0.1 | 0.1 | 0.1 | 0.1 | 0.1 | 0.1 | 0.1 | | 0.1 |
| Zinc oxide | 22.8 | 24.0 | 22.1 | 23.3 | 22.8 | 23.5 | 24.5 | 22.8 | 23.8 | 22.8 | 23.8 | 30.0 | 21.1 | 23.5 |
| Zinc salt of | 1.0 | 1.0 | 1.0 | 1.0 | 1.0 | 1.0 | 1.0 | 1.0 | 1.0 | 1.0 | 1.0 | | 1.0 | 1.0 |
| pentachlorothiophenol | | | | | | | | | | | | | | |

Details on the above formulations are given below.

Polybutadiene: Available under the trade name “BR 730” from JSR Corporation
Zinc acrylate: Available under the trade name “ZN-DA85S” from Nippon Shokubai Co., Ltd.
Organic Peroxide (I): Dicumyl peroxide, available under the trade name “Percumyl D” from NOF Corporation
Organic Peroxide (H): A mixture of 1,1-di(t-butylperoxy)cyclohexane and silica, available under the trade name “Perhexa C40” from NOF Corporation
Water: Distilled water
Antioxidant I): Available under the trade name “Nocrac MB” from Ouchi Shinko Chemical Industry Co., Ltd.
Antioxidant (II): Available under the trade name “Nocrac NS-6” from Ouchi Shinko Chemical Industry Co., Ltd.
Zinc oxide: Available as “Zinc Oxide Grade 3” from Sakai Chemical Co., Ltd.
Zinc salt of pentachlorothiophenol:
Available from Zhejiang Shou & Fu Chemical Co., Ltd.

### Cross-Sectional Hardnesses of Core

The cross-sectional hardnesses at various positions, including the surface and center, of the 37.6 mm diameter core in each of the above Examples and Comparative Examples are measured by the following methods.

### (1) Surface Hardness of Core

At a temperature of 23±1° C., the hardnesses at four random points on the core surface are measured with a JIS-C durometer by perpendicularly setting the indenter of the durometer against the spherical surface of the core. The average value of these measurements is treated as the measured value for one core, and the average value for three measured cores is determined. These results are presented in Table 3.

### (2) Cross-Sectional Hardnesses of Core

The core is cut through the center to obtain a flat cross-sectional plane. At a temperature of 23±1° C., the hardnesses at the center of the hemispherical core and at 2 mm intervals from the center toward the surface are measured with a JIS-C durometer by perpendicularly setting the indenter of the durometer against the flat cross-section, thereby collecting the measurements for one core. The average values for three measured cores are determined. Those results are presented in Table 3.

### Compressive Deformation (Deflection) of Core and Ball

The compressive deformations (mm) of each core and ball when compressed at a speed of 10 mm/s under a final load of 1,275 N (130 kgf) from an initial load of 98 N (10 kgf) are measured at a temperature of 23±1° C. In each case, the average value for ten measured cores or balls is determined.

### Formation of Intermediate Layer and Cover (Outermost Layer),

In Examples 1 and 2 and Comparative Examples 1 and 2, the intermediate layer-forming resin material A shown in Table 2 was then injection-molded over the surface of the core using an injection mold, thereby forming an intermediate layer having a thickness of 1.30 mm and a Shore D hardness of 57. Next, using a different injection mold, the cover (outermost layer)— forming resin material C shown in Table 2 was injection-molded over the intermediate layer-encased sphere, thereby forming a cover having a thickness of 1.25 mm and a Shore D hardness of 62.

In Examples 3 to 5 and Comparative Examples 3 to 9, the intermediate layer-forming resin material A or B shown in Table 2 is then injection-molded over the surface of the above core using an injection mold, thereby forming an intermediate layer having a thickness of 1.30 mm and a Shore D hardness of 57 or 51. Next, using a different injection mold, the cover (outermost layer)— forming resin material C or D shown in Table 2 is injection-molded over the intermediate layer-encased sphere, thereby forming a cover having a thickness of 1.25 mm and a Shore D hardness of 62 or 60.

TABLE 2

| Resin formulation (pbw) | A | B | C | D |
|---|---|---|---|---|
| HPF 1000 | 56 | 100 | | |
| Himilan 1605 | 44 | | | |
| AM 7318 | | | 75 | 60 |
| AM 7327 | | | 25 | 40 |
| Titanium oxide | | | 4 | 4 |

Details on the compounding ingredients in the above table are given below.

HPF 1000: Dow^{™HPF} 1000 from The Dow Chemical Company
Himilan® 1605: An ionomer resin from Dow-Mitsui Polychemicals Co., Ltd.
AM7318: An ionomer resin from Dow-Mitsui Polychemicals Co., Ltd.
AM7327: An ionomer resin from Dow-Mitsui Polychemicals Co., Ltd.
Titanium oxide: from Sakai Chemical Co., Ltd.

The spin rates on shots with a driver of the golf balls obtained in each Example are evaluated by the following method. The results are shown in Table 3.

Spin Rate on Shots with Driver (W #1)

A PHYZ Driver (loft angle, 10.5°) manufactured by Bridgestone Sports Co., Ltd. was mounted on a golf swing robot and the rate of backspin by the ball when struck at a head speed (HS) of 45 m/s was measured.

TABLE 3

| | | | Example | | | | | Comparative Example | |
|---|---|---|---|---|---|---|---|---|---|
| | | | 1 | 2 | 3 | 4 | 5 | 1 | 2 |
| Core | Diameter (mm) | | 37.6 | 37.6 | 37.6 | 37.6 | 37.6 | 37.6 | 37.6 |
| | Compressive | | 4.6 | 5.0 | 4.6 | 5.0 | 4.6 | 4.6 | 5.0 |
| | deformation (mm) | | | | | | | | |
| | Surface | JIS-C | 80.0 | 74.5 | 80.2 | 75.0 | 80.0 | 78.0 | 74.0 |
| | hardness | | | | | | | | |
| | Center | | 54.8 | 50.8 | 54.6 | 50.2 | 54.8 | 56.0 | 54.5 |
| | hardness | | | | | | | | |
| | Surface − | | 25.2 | 23.7 | 25.6 | 24.8 | 25.2 | 22.0 | 19.5 |
| | Center | | | | | | | | |
| | Surface | Shore D | 52.5 | 47.5 | 52.7 | 48.0 | 52.5 | 50.7 | 47.1 |
| | hardness | | | | | | | | |
| | Center | | 29.9 | 26.3 | 29.7 | 25.7 | 29.9 | 30.9 | 29.6 |
| | hardness | | | | | | | | |
| | Surface − | | 22.6 | 21.3 | 23.0 | 22.3 | 22.6 | 19.8 | 17.5 |
| | Center | | | | | | | | |
| Intermediate | Material | | A | A | A | A | B | A | A |
| layer | Thickness (mm) | | 1.3 | 1.3 | 1.3 | 1.3 | 13 | 1.3 | 1.3 |
| | Material hardness | | 57 | 57 | 57 | 57 | 51 | 57 | 57 |
| | (Shore D) | | | | | | | | |
| Cover | Material | | C | C | C | C | D | C | C |
| | Thickness (mm) | | 1.25 | 1.25 | 1.25 | 1.25 | 1.25 | 1.25 | 1.25 |
| | Material hardness | | 62 | 62 | 62 | 62 | 60 | 62 | 62 |
| | (Shore D) | | | | | | | | |
| Ball | Compressive | | 3.25 | 3.50 | 3.25 | 3.50 | 3.45 | 3.25 | 3.50 |
| | deformation (mm) | | | | | | | | |
| Cover material hardness − | | | 32.1 | 35.7 | 32.3 | 36.3 | 30.1 | 31.1 | 32.4 |
| Core center hardness | | | | | | | | | |
| (Shore D) | | | | | | | | | |
| Spin rate on driver | | | 2,597 | 2,581 | 2,565 | 2,548 | 2,643 | 2,667 | 2,649 |
| (W#1) shots (rpm) | | | | | | | | | |
| | | | Comparative Example | | | | | | |
| | | | 3 | 4 | 5 | 6 | 7 | 8 | 9 |
| Core | Diameter (mm) | | 37.6 | 37.6 | 37.6 | 37.6 | 37.6 | 37.6 | 37.6 |
| | Compressive | | 4.6 | 5.0 | 4.6 | 5.0 | 4.4 | 4.0 | 4.6 |
| | deformation (mm) | | | | | | | | |
| | Surface | JIS-C | 78.7 | 76.3 | 78.5 | 75.1 | 77.0 | 84.2 | 78.0 |
| | hardness | | | | | | | | |
| | Center | | 55.5 | 54.0 | 55.5 | 54.0 | 62.0 | 58.5 | 56.0 |
| | hardness | | | | | | | | |
| | Surface − | | 23.2 | 22.3 | 23.0 | 21.1 | 15.0 | 25.7 | 22.0 |
| | Center | | | | | | | | |
| | Surface | Shore D | 51.3 | 49.2 | 51.1 | 48.1 | 49.8 | 56.3 | 50.7 |
| | hardness | | | | | | | | |
| | Center | | 30.5 | 29.1 | 30.5 | 29.1 | 36.3 | 33.2 | 30.9 |
| | hardness | | | | | | | | |
| | Surface − | | 20.8 | 20.0 | 20.7 | 18.9 | 13.5 | 23.1 | 19.8 |
| | Center | | | | | | | | |

| | | | | | | | | |
|---|---|---|---|---|---|---|---|---|
| Intermediate | Material | A | A | A | A | A | A | B |
| layer | Thickness (mm) | 1.3 | 1.3 | 1.3 | 1.3 | 1.3 | 1.3 | 1.3 |
| | Material hardness | 57 | 57 | 57 | 57 | 57 | 57 | 51 |
| | (Shore D) | | | | | | | |
| Cover | Material | C | C | C | C | C | C | D |
| | Thickness (mm) | 1.25 | 1.25 | 1.25 | 1.25 | 1.25 | 1.25 | 1.25 |
| | Material hardness | 62 | 62 | 62 | 62 | 62 | 62 | 60 |
| | (Shore D) | | | | | | | |
| Ball | Compressive | 3.25 | 3.50 | 3.25 | 3.50 | 3.50 | 2.80 | 3.45 |
| | deformation (mm) | | | | | | | |

| | | | | | | | |
|---|---|---|---|---|---|---|---|
| Cover material hardness − | 31.5 | 32.9 | 31.5 | 32.9 | 25.7 | 28.8 | 29.1 |
| Core center hardness | | | | | | | |
| (Shore D) | | | | | | | |
| Spin rate on driver | 2,655 | 2,631 | 2,658 | 2,642 | 2,736 | 2,688 | 2,685 |
| (W#1) shots (rpm) | | | | | | | |

As shown in Table 3, it is apparent that the golf balls in Examples 1 to 5 have an increased hardness difference between the core surface and the core center and that the spin rate on shots with a driver decreases, giving the ball an improved spin performance.

By contrast, compared with the golf balls obtained in the Examples of the invention, it is apparent from the graph in FIG. 1 that the spin rate of the ball on shots with a driver (W #1) is relatively high in Comparative Examples 1 to 9.

The ball in Comparative Example 1 has a small hardness difference between the core surface and core center relative to Examples 1 and 3, As a result, the spin rate of the ball on shots with a driver (W #1) is high.

The ball in Comparative Example 2 has a small hardness difference between the core surface and core center relative to Examples 2 and 4. As a result, the spin rate of the ball on shots with a driver (W #1) is high.

The ball in Comparative Example 3 has a small hardness difference between the core surface and core center relative to Examples 1 and 3. As a result, the spin rate of the ball on shots with a driver (W #1) is high.

The ball in Comparative Example 4 has a small hardness difference between the core surface and core center relative to Examples 2 and 4. As a result, the spin rate of the ball on shots with a driver (W #1) is high.

The ball in Comparative Example 5 has a small hardness difference between the core surface and core center relative to Examples 1 and 3. As a result, the spin rate of the ball on shots with a driver (W #1) is high.

The ball in Comparative Example 6 has a small hardness difference between the core surface and core center relative to Examples 2 and 4. As a result, the spin rate of the ball on shots with a driver (W #1) is high.

The ball in Comparative Example 7 has a small hardness difference between the core surface and core center relative to Examples 1 to 5. As a result, the spin rate of the ball on shots with a driver (W #1) is high.

The ball in Comparative Example 8 has a low ball compressive deformation compared with Example 1. As a result, the spin rate of the ball on shots with a driver (W #1) is high.

The ball in Comparative Example 9 has a small hardness difference between the core surface and core center relative to Example 5. As a result, the spin rate of the ball on shots with a driver (W #1) is high.

Japanese Patent Application No. 2021-092015 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A golf ball comprising a core; a cover and at least one intermediate layer interposed between the core and the cover, wherein the core is made of a material molded under heat from a rubber composition comprising:
(a) a base rubber,
(b) a co-crosslinking agent which is an α,β-unsaturated carboxylic acid or a metal salt thereof or both,
(c) an organic peroxide,
(d) water, and
(e) an antioxidant which is a benzimidazole of the following general formula or a metal salt thereof or both 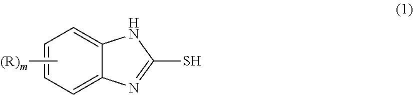
(wherein R is a hydrogen atom or a hydrocarbon group of 1 to 20 carbon atoms and m is an integer from 1 to 4, with each R being the same or different when m is 2 or more);
the core has a compressive deformation of at least 4.1 mm when compressed under a final load of 1,275 N (130 kgf) from an initial load of 98 N (10 kgf); and the ball has a compressive deformation of at least 3.0 mm when compressed under a final load of 1,275 N (130 kgf) from an initial load of 98 N (10 kgf).

2. The golf ball of claim 1, wherein component (e) is 2-mercaptobenzimidazole.

3. The golf ball of claim 1; wherein the content of component (d) per 100 parts by weight of component (a) is at least 1.0 part by weight and the content of component (e) per 100 parts by weight of component (a) is at least 0.1 part by weight.

4. The golf hail of claim 1, wherein the intermediate layer has a material hardness on the Shore D hardness scale of at least 50, the cover has a material hardness on the Shore D hardness scale of at least 60, and the golf ball satisfies the following hardness relationship:
(1) material hardness of cover>material hardness of intermediate layer>core surface hardness>core center hardness.

5. The golf ball of claim 4, wherein the hardness relationship between the core and the cover satisfies the following condition:
(2) (Shore D hardness of cover material)—(Shore D hardness at core center)≥30.
